(19) United States
(12) Patent Application Publication
(10) Pub. No.: US 2009/0273268 A1
(43) Pub. Date: Nov. 5, 2009

(54) LAMP FOR A LIGHT SYSTEM

(75) Inventor: Markus Gerhard, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/440,596

(22) PCT Filed: Sep. 10, 2007
(86) PCT No.: PCT/IB2007/053642

§ 371 Date: Mar. 10, 2009

(30) Foreign Application Priority Data
Sep. 14, 2006 (EP) 06120693.4

(51) Int. Cl. H01J 5/00; H01J 9/24

(52) U.S. Cl. 313/317; 445/23

(57) ABSTRACT

The invention relates to a lamp for a light system, which lamp comprises at least: a lamp envelope (1) in which at least one electrical radiant source is enclosed and from which project at least two current supply means, a lamp base (2) that has at least one part by which the lamp envelope is fixed to the lamp base, and a reference element (3, 4) that is arranged on the lamp base wherein the material of the part of the lamp base by which the lamp base (2) is fixed to the lamp envelope (1) is composed of a plastics material or a mixture of plastics materials that is resistant to high temperatures.

The invention relates to a lamp for a light system, which lamp comprises at least: a lamp envelope in which at least one electrical radiant source is enclosed and from which project at least two current supply means, a lamp base that has at least one part by which the lamp envelope is fixed to the lamp base, and a reference element that is arranged on the lamp base.

Lamps of this kind are used in large numbers in for example light systems forming part of a motor vehicle lighting system and, particularly in the case of specific types of lamp and especially what are called HPH lamps (high performance halogen lamps), are widely employed for an enormous variety of applications.

What may be mentioned as types of lamp for motor vehicle lighting systems of the kind to which the invention relates are for example the types known as HB 4, H7, H8, H9, and H11 lamps and D1, D2, D3 and D4 lamps.

At the present time, standard commercial HPH lamps (H8, H9 and H11 lamps) are constructed as follows:

The lamp, a single-filament halogen incandescent lamp, that is intended for use in a motor vehicle headlamp has a glass lamp envelope enclosing an incandescent filament. Two current supply means, which project from the end of the lamp envelope adjacent the base, are used to hold the incandescent filament in place and to supply it with current. The glass lamp envelope is connected to a metal holder by a normal force fit. The metal holder is fixed to the metal adjusting ring that is welded to the reference element, which is often a reference ring. The metal reference ring has three reference lugs. When the three above-mentioned metal base parts are being welded together, the incandescent filament is lined up relative to the three reference lugs by standard adjusting processes.

The reference ring that is used for referencing relative to a part of the light system, such as the reflector for example, is fixed to the top part of the lamp base. The basic material of the lamp base is a plastics material. The base is thus a plastics injection molding and the reference ring is normally fastened to this plastics injection molding in a fixed position during the injection process. During the assembly process, the metal parts, i.e. the holder, the adjusting ring and the reference ring, and the part made of plastics material, have to be connected together to form the lamp in such a way that certain tolerances, that are normally standardized (ECE R37), are met. For their manufacture, and for their exact positioning and fixing in place relative to one another, the relatively large number of separate metal parts calls for not inconsiderable technological cost and complication and financial expenditure. In industrial mass production, development work is focused on the making of even very small savings.

With regard to the making of an electrically conductive connection between the current supply means that project from the end of the lamp envelope adjacent the base and the contact elements, there are at the moment two known variant procedures.

In the first variant, known as the open variant, an opening that can be closed off by a cover is provided in the plastics lamp base. This opening makes it possible for the current supply means to be connected to the contacts once the lamp envelope has been assembled to the lamp base. This open variant has the disadvantage of requiring a further component, namely the cover. Also, there are limits to how far the lamp base can be produced in such a way as to be sealed, which means that this solution can be ruled out for certain applications.

In the second variant that is known at the moment, the variant that is called the closed variant, the lamp base comprises only a plastics part. As in the first variant, so in this case too does the connection of the current supply means to the contacts take place after the assembly of the lamp envelope to the lamp base. Two openings are provided in one of the three metal parts for this purpose. The handling operations that the connection involves are technologically demanding due, amongst other things, to the possible size of the openings, which can only be small.

It is an object of the invention, using a lamp base of plastics material, to provide a lamp having as few metal parts as possible. The way of achieving the object is also intended to make possible a closed variant of a lamp base of this kind. It is also to be possible for the lamp to be manufactured efficiently by industrial mass production while observing the relevant standards.

This object of the invention is achieved by virtue of the features of a lamp for a light system that are specified in claim 1.

What is material to the invention is that the material of the part of the lamp base by which the lamp base is fixed to the lamp envelope is composed of a plastics material or a mixture of plastics materials that is resistant to high temperatures.

The construction of the new lamp and the way in which it is manufactured make it possible for the number of metal parts that has long been normal in the past to be reduced. It is thus possible for these lamps to be manufactured with greater efficiency, although the relevant standards are still met. In industrial mass production, this solution can be implemented inexpensively and can be adjusted to suit the standard of the particular product.

It becomes possible for the lamp base to be regularly of the closed variant, which means that the advantages of the latter do not have to be paid for by the need for additional technical provisions. In many cases this results in an additional advantage for the user.

For the purposes of the invention, plastic materials or mixtures of plastics material that are resistant to high temperatures have a temperature resistance of at least 250° C. The particular material concerned will be selected as a function of the given type of lamp, or rather of the temperature conditions to which the type of lamp is subject. Preferred materials are materials from the PPS group of products (Ryton, Fortron) and LCP.

Dependent claims 2 to 7 specify advantageous embodiments of the lamp according to the invention without constituting a full and final listing of such embodiments.

It is preferable for the lamp base to be a one-piece injection molding. Basically, it is possible, for specific applications, for the lamp base to be injection molded and produced in at least two parts, use being made in each case of separate materials having different properties in respect of, for example, temperature resistance or accuracy of surface geometry. For normal applications, however, a one-piece injection molding of plastics material is preferred from the technological point of view.

It is also preferable for the reference element to be an integral component of the lamp base, meaning that the reference element is a component of the injection molding of plastics material. The metal reference element is replaced, as a separate element, in its entirety. For particular applications there is no need for the reference element to have any metallic properties, which means that the properties of the plastics material, which can if necessary be determined by selecting a material that is separate but, in itself, normal, will meet the requirements that exist.

It is also preferable for the reference element to be arrangeable in such a way as to correspond to a reference and fixing element belonging to the light system. This makes it possible for the reference element of the lamp also to have and implement the function of a fixing element either completely or at least in part.

These and other aspects of the invention are apparent from and will be elucidated with reference to the embodiments described hereinafter.

In the drawings:

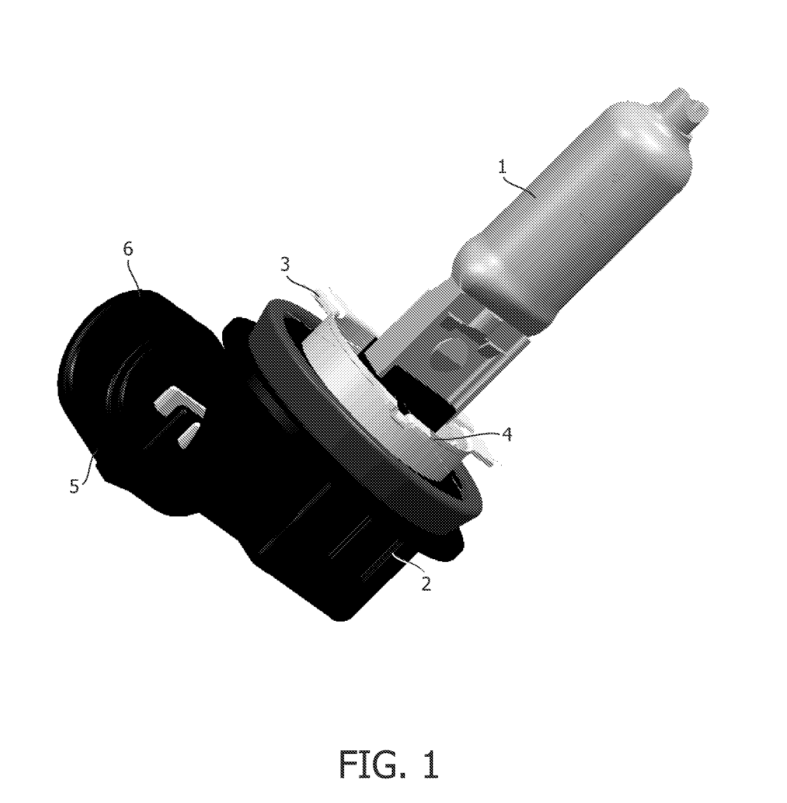

FIG. 1 is a schematic view from the side of a lamp according to the invention for a motor vehicle headlamp system.

The embodiment of the invention that is shown in FIG. 1 is a single-filament halogen incandescent lamp that is intended for use in a motor vehicle headlamp. The lamp has a substantially cylindrical glass envelope 1 enclosing an incandescent filament that is arranged in the normal fashion approximately parallel to the longitudinal axis of the lamp. Two current supply means (not shown in FIG. 1), which project from the end of the lamp envelope 1 adjacent the base, are used to hold the incandescent filament in place and to supply it with current. The end of the lamp envelope 1 adjacent the lamp base 2 is solidly connected to a part of the said lamp base 2. The lamp base 2 has a metal reference element 4 that is in the form of a reference ring. The material of the lamp base 2 is molded round the reference ring. The reference ring has three reference lugs 3 that extend radially outwards perpendicularly to the longitudinal axis and that lie in a single plane. The reference lugs 3 are, in the usual way, arranged at intervals of 120° around the circumference of the reference ring. When the current supply means are being welded to the contact elements 5, the incandescent filament is precisely aligned relative to the three reference lugs 3 and the reference plane defined thereby by means of the normal adjusting processes so that, when the lamp is fitted into a headlamp, the position of the incandescent filament in the reflector can likewise be unambiguously fixed by the orientation and fitted position of the three reference lugs 3 within the headlamp reflector. The reference element 4 is arranged and sized in the usual way so that it will cooperate, in the manner dictated by its function, with the corresponding reference and fixing element belonging to the headlamp reflector of the light system.

The lamp is what is called an HPH lamp (H8, H9, H11), which means that the current supply means and the contact elements 5 are connected together in a known manner by welded, electrically conductive connections, with the current supply means extending approximately parallel to the longitudinal axis of the lamp and the contact elements 5 being arranged approximately perpendicularly to the longitudinal axis of the lamp.

The lamp base 2 is a one-piece injection molding, i.e. it does not, in particular, have a cover and is what is called a closed base.

What is used as a material for the lamp base 2 is a high-temperature resistant plastics material, PPS (Ryton 120 BL) in the present case. Comparable plastics materials or mixtures thereof, such as LCP or Fortron, could be used as alternatives.

Part of the lamp base 2 encloses at least the bottom part of the lamp envelope. The reference element 4 is thus partly embedded and held in a fixed position in the material of the lamp base 2, and parts of the current supply means, namely those parts that project from the lamp envelope 1, and a part of the contact elements 5, are thus completely embedded and held in a fixed position therein. Part of the lamp base 2 acts as a connecting socket 6 for the electrical power supply, the free ends of the contact elements 5 being arranged in the normal way in the cavity in the connecting socket 6. The lamp base 2 complies at least with European standards, such for example as the ECE regulations for R37 lamp bases.

To connect the lamp, having at least one radiant source, of a light system, such as a motor vehicle lighting system, to another part of the light system, such as the reflector housing for the lamp, the lamp is inserted, along its longitudinal axis, in an opening in the light system and is fastened in this opening by turning it circumferentially.

The main steps in which the parts of the lamp according to the invention are connected are, in essence, the following:

The lamp envelope 1, the reference element 4 and the contact elements 5 are placed in the mold of an automatic injection molding machine and exactly positioned relative to one another. The current supply means of the lamp envelope 1 and the contact elements 5 are then connected solidly together by electrically conductive connections in a known manner, by welding for example. The mold of the automatic injection molding machine is closed and the fluidified material for the lamp base 2 is fed in. The mold is then opened and the injection molding removed therefrom in the usual way. The lamp envelope 1, the reference element 4 and the contact elements 5 are now firmly connected to the solidified plastics material.

1. A lamp for a light system, comprising at least:
a lamp envelope (1) in which at least one electrical radiant source is enclosed and from which project at least two current supply means,
a lamp base (2) that has a part by which the lamp base (2) is fixed to the lamp envelope (1), and
a reference element (4) that is arranged on the lamp base (2),
wherein the material of the part of the lamp base by which the lamp base (2) is fixed to the lamp envelope (1) is composed of a plastics material or a mixture of plastics materials that is resistant to high temperatures.

2. A lamp as claimed in claim 1, characterized in that the lamp base (2) is a one-piece injection molding.

3. A lamp as claimed in claim 1, characterized in that the reference element (4) is an integral part of the lamp base (2).

4. A lamp as claimed in claim 1, characterized in that the material of the lamp base (2) is molded round the reference element (4).

5. A lamp as claimed in claim 2, characterized in that the current supply means are connected to contact elements (5) by electrically conductive connections, the current supply means extending approximately parallel to the longitudinal axis of the lamp and the contact elements (5) being arranged approximately perpendicularly or parallel to the longitudinal axis of the lamp.

6. A lamp as claimed in claim 1, characterized in that the reference element (4) is arrangeable in such a way as to correspond to a reference and fixing element belonging to the light system.

7. A lamp as claimed in claim 1, characterized in that the plastics material resistant to high temperatures is PPS (Ryton, Fortron) or LCP.

8. A lamp as claimed in claim 1, characterized in that the lamp is a halogen lamp having at least one incandescent filament.

9. A method of manufacturing a lamp as claimed in claim 5, having the following steps:
placing of the lamp envelope (1), the reference element (4) and the contact elements (5) in the mold of an automatic injection molding machine,
positioning of the lamp envelope (1), the reference element (4) and the contact elements (5) relative to one another,
connecting of the current supply means of the lamp envelope (1) to the contact elements (5),
closing of the mold of the automatic injection molding machine,
feeding in of the fluidified material of the lamp base 2,
cooling and curing of the material of the lamp base 2 to form the injection molding for the lamp base 2,
opening of the mold of the automatic injection molding machine and removal of the injection molding from the mold.
